(19) United States
(12) Patent Application Publication
(10) Pub. No.: US 2009/0077243 A1
(43) Pub. Date: Mar. 19, 2009

(54) CONVERSATION RECOVERY METHOD

(76) Inventors: Dinesh Garg, (US); Brent Hailpern, Katonah, NY (US); Nandakishore Kambhatla, (US); Peter K. Malkin, Ardsley, NY (US); Mark N. Wegman, Ossining, NY (US)

Correspondence Address: SCULLY, SCOTT, MURPHY & PRESSER, P.C., 400 GARDEN CITY PLAZA, SUITE 300, GARDEN CITY, NY, 11530, US

(21) Appl. No.: 11/855,511

(22) Filed: Sep. 14, 2007

(51) Int. Cl. G06F 15/16

(52) U.S. Cl. 709/228

(57) ABSTRACT

A system for recovering from an interruption of communication on a network between computer users which includes a computer network connecting a plurality of users using computers in a communication session. A computer readable medium encoded with a computer program is connected to at least one of the users' computers for storing generated communication between the users during the communication session. The computer program reconnects the session between the users, and restores the generated communication between the users after detecting an interruption of the session.

### FIELD OF THE INVENTION

The present invention relates to a system and method of restarting a communication over a computer network, and more specifically, restarting a communication session over a computer network including the context of the original communication when the communication is interrupted abnormally.

### BACKGROUND OF THE INVENTION

Online conversation applications, for example, used by customer help services (help desk), between a customer and a customer service representative or agent for a company have become increasingly important and prolific. However, one problem which arises when a conversation session is abnormally interrupted, is the text of the conversation session is lost. For example, a session interruption can occur when the customer's machine must be restarted (e.g., so as to complete an installation or repair task), or an unexpected power outage. Not only does this result in the entire context of the session being lost, but also the user must try to reconnect to and re-contact the help service. However, this typically results in the client being connected to a different support technician from the original support technician who was familiar with the client's problem before the session interruption. Thus, the client and the new support technician are forced to start the whole problem resolution process anew, since the previous conversations context is lost. Efforts to resolve this problem include a software package which saves conversation history after a system reboot, however, the software package only allows explicit back pointers (e.g., email addresses) to particular support personnel.

Therefore, a need exists for a system and method that allows a client to re-connect to a particular support technician after the client's communication service is disconnected re-started in mid-conversation or during a communication session. Further, a need exits for the re-connected client and representative to have access to all of the text or data from the original conversation or communication session.

### SUMMARY OF THE INVENTION

In an aspect of the invention, a system for recovering from an interruption of communication on a network between computer users includes a computer network connecting a plurality of users using computers in a communication session. A computer readable medium is encoded with a computer program embodied therein, and the computer readable medium is connected to at least one of the users' computers for storing generated communications between the users during the communication session. The computer program reconnects the session between the users and restores the generated communications between the users after detecting—an interruption of the session between the users.

In a related aspect, the computers include a server including the computer readable medium and a client computer. Further, the session may be asynchronous. Additionally, an application server may include the computer readable medium and manages the session between the plurality of users. Also, a customer service agent may communicate using the server with a customer using a client computer. Further, a servicing computer may include the computer readable medium and communicate with the users computers.

In a related aspect, the program initiates deleting the generated communications of a completed communication session from the computer readable medium. Further, the session may be synchronous. Additionally, the program may provide a link to each of the users to reconnect the session. Additionally, the generated communications include text and/or voice communications. Also, the program may not allow reconnection to a previous user by another previous user after expiration of the communication session. Further, the expiration of the communication session may include a specified time and/or the communication session has been completed.

In another aspect of the invention, a method for recovering from an interruption of communication on a network between computer users includes: connecting via a computer network a plurality of users using computers in a communication session; generating communications between the users during the communication session; storing the generated communications between the users; interrupting the session between the users; reconnecting the session between the users; and restoring the generated communications between the users.

In a related aspect, the method further includes blocking reconnection between the users after a specified period of time and/or after completing the session between the users. Further, the method further comprises deleting the generated communication after the communication session is completed. Additionally, reconnecting the session may include sending each of the users a link to reconnect the session, and selecting the link by the users reconnects the session.

In another aspect of the invention, a computer readable media having computer readable program code embodied therein for executing a method for recovering from an interruption of communication on a network between computer users, the computer readable program code configured for executing method steps comprises: connecting via a computer network a plurality of users using computers in a communication session; generating communication between the users during the communication session; detecting an interruption of the session between the users; reconnecting the session between the users; and restoring the generated communication between the users.

In a related aspect, the method further comprises deleting the generated communication after the communication session is completed. Further, reconnecting the sessions may include sending each of the users a link to reconnect the session, and selecting the link by the users reconnects the session.

In another aspect of the invention, a computer program product embodied in a computer-readable medium encoded with a computer program therein for executing a method for recovering from an interruption of communication on a network between computer users, the computer program product comprises: displaying generated communications by the users during a communication session; reconnecting the session between the users after detecting the communication session has been interrupted; and restoring the generated communication between the users.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a block diagram according to an embodiment of the invention illustrating a network topology including a client and a server;

FIG. 2 is a block diagram illustrating the server depicted in FIG. 1 embodied as a helpdesk server;

FIG. 3 is a flow diagram illustrating flow control of the helpdesk server shown in FIGS. 1 and 2;

FIG. 4 is a flow diagram of the connection handler shown in FIG. 2;

FIG. 5 is a flow diagram of the new ticket handler which in FIG. 2;

FIG. 6 is a flow diagram of the pervious ticket handler shown in FIG. 2;

FIG. 7 is a flow diagram of the server session handler in one embodiment of the present disclosure;

FIG. 8 is a block diagram illustrating the client node shown in FIG. 1 embodied as a helpdesk client node;

FIG. 9 is a flow diagram illustrating flow control of the helpdesk client node shown in FIG. 8;

FIG. 10 is a flow diagram of the client connection handler shown in FIG. 8;

FIG. 11 is a flow diagram of the client session handler shown in FIG. 8;

FIG. 12 is a block diagram of a client connection graphical user interface (GUI) in an embodiment of the disclosure; and

FIG. 13 is a block diagram of a client session using the GUI interface shown in FIG. 12 in an embodiment of the invention.

### DETAILED DESCRIPTION OF THE INVENTION

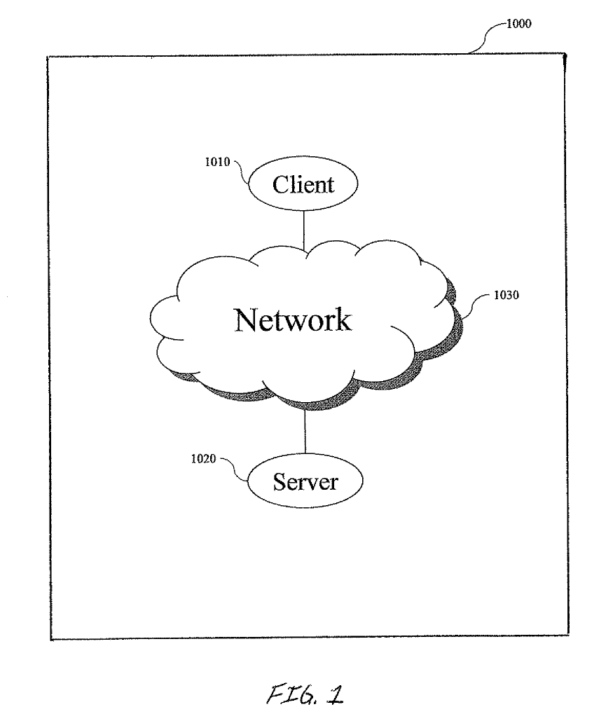

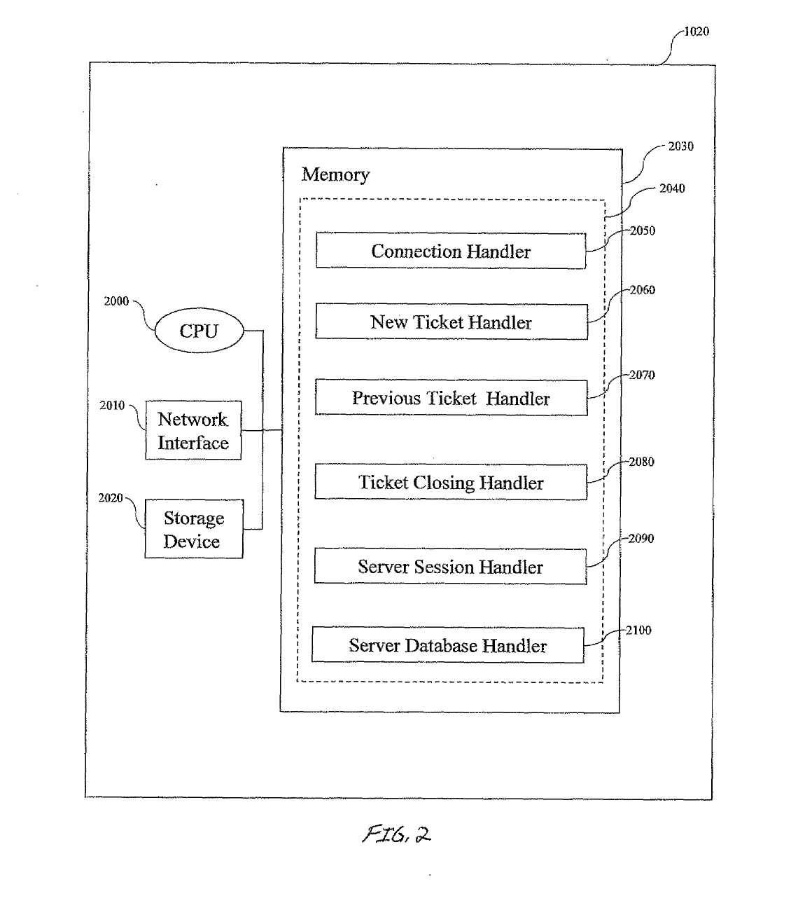

An illustrative embodiment of a system and method 1000 according to the present invention includes a network topology 1000 shown in FIG. 1. A client node 1010 is where the customer or user of a helpdesk service is working, and server node 1020 is used by a help desk specialist, customer service representative, or any other type of agent providing an online service. The client node 1010 and the server node 1020 communicate with each other via a network 1030 which allows a user and an agent to engage in a communication session, including, for example, messaging, or an on-line conversation, or the like. It is understood that the client or client node 1010 as used herein is intended to include the client node, as well as, a user at the client node 1010 receiving, viewing, and responding to message in communication with an agent at the server node 1020. Likewise, it is understood that the server or server node 1020 as used herein is intended to include the server node, as well as, the agent at the server node 1010 receiving, viewing, and responding to message in communication with the user at the client node 1010. It is further understood that a single client 1010 is shown in FIG. 1 for illustrative purpose, and that a plurality of clients may also be communicating with server nodes. The network 1030 includes, for example, the Internet, an intranet, or a wireless or wired telecommunication network. Referring to FIG. 2, the server 1020 includes any computing node that is able to load and execute programmatic code and communicate via a network, including, for example, IBM® ThinkPad® or PowerPC®, running an operating system and a server application suite including, for example, Microsoft® Windows® XP, or a Linux™ operating system.

As shown in FIG. 2, server 1020 preferably includes a processor device embodied as CPU 2000, a network interface 2010, a storage device 2020 such as a magnetic or optical disk storage or a direct access storage device (DASD), and a memory 2030, such as RAM. The server logic 2040 is embodied as computer executable code that is loaded from a remote source (e.g., over the network 1030 via the network interface 2010), local permanent optical disks (e.g., Compact Disk read-only memory (CD-ROM)), magnetic storage (such as a disk), or a direct access storage device (DASD) 2020 into memory 2030 for execution by CPU 2000. Generally, the memory 2030 includes computer readable instructions, data structures, program modules and application interfaces as embodied in the server logic 2040 as a connection handler 2050, a new ticket handler 2060, a previous ticket handler 2070, a ticket closing handler 2080, a server session handler 2090, and a server database handler 2100. The server database handler 2100 provides creation, deletion and modification of user-problem-support related information or data in a database, and is used by the handlers 2050-2090 of the server 1020. One example of a product providing such functions includes the DB/2® database system by IBM®.

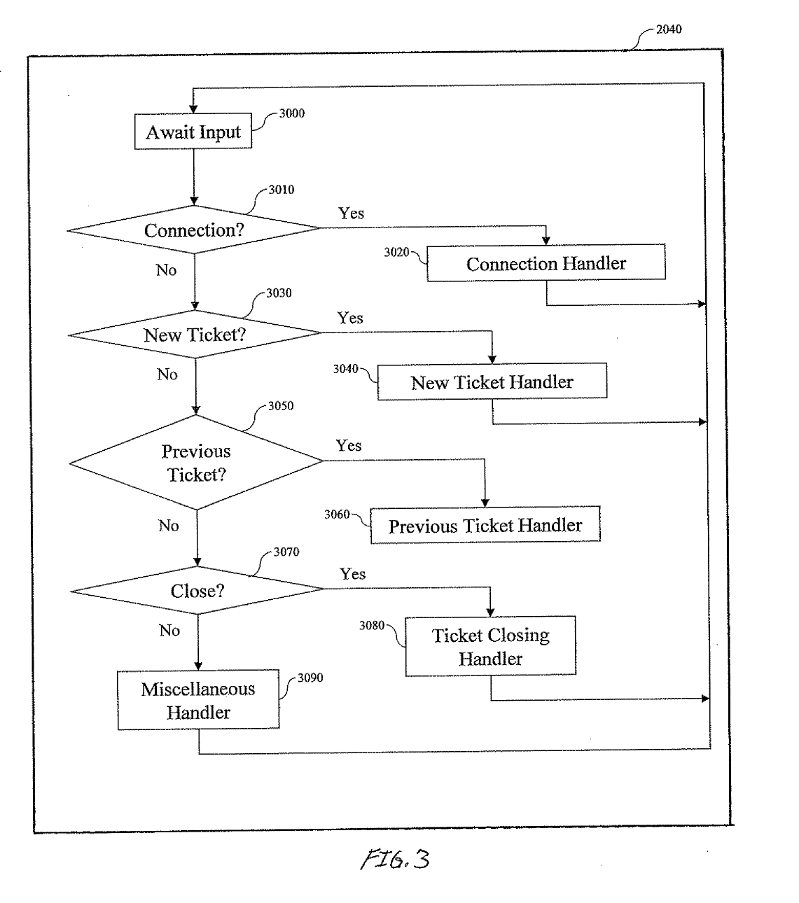

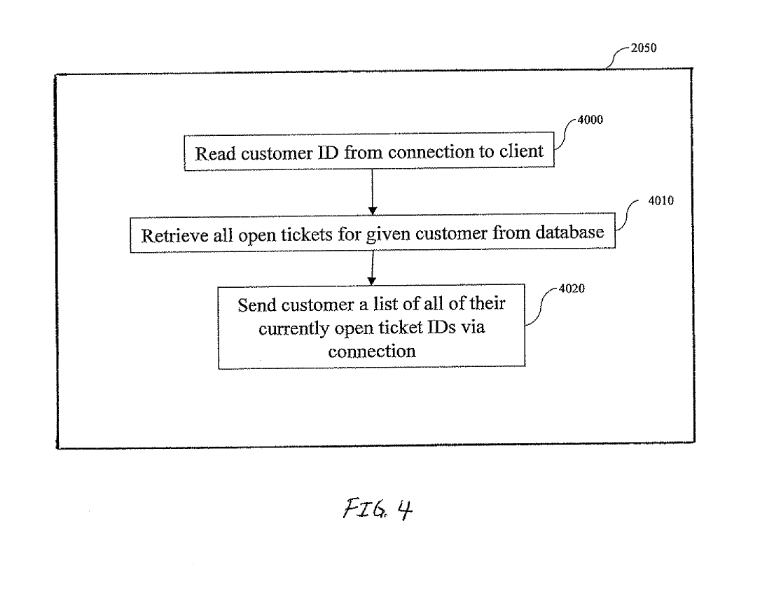

Referring to FIG. 3, where steps according to the invention are indicated by reference numerals, as well as in the flow charts of FIGS. 4-7 and 9-11, a flow chart of the control flow of the server's logic 2040 includes the server 1020 waiting for input 3000. When an input is received 3010, the server's logic determines whether it is a request for a helpdesk connection. If so, the connection handler 2050 is invoked in step 3020. If the input is not a request for a connection, then step 3030 determines whether it is a request for a new problem ticket. If so, the new ticket handler 2060 is invoked in step 3040. If the input is not a request for a new problem ticket, step 3050 determines whether it is a request for a previous problem ticket. If the input is a request for a previous problem ticket, the previous ticket handler 2070 is invoked 3060. If the input is not a request for a previous ticket, then a determination is made whether to close a ticket 3070. If the ticket is closed, the ticket closing handler 2080 is invoked 3080, and the ticket closing handler 2080 takes the given ticket ID and deletes the entry in the server database handler 2100 related to it. Alternatively, the entry could be archived or logged before it is deleted. If the input is not a request for closing a ticket, then a miscellaneous handler is invoked 3090.

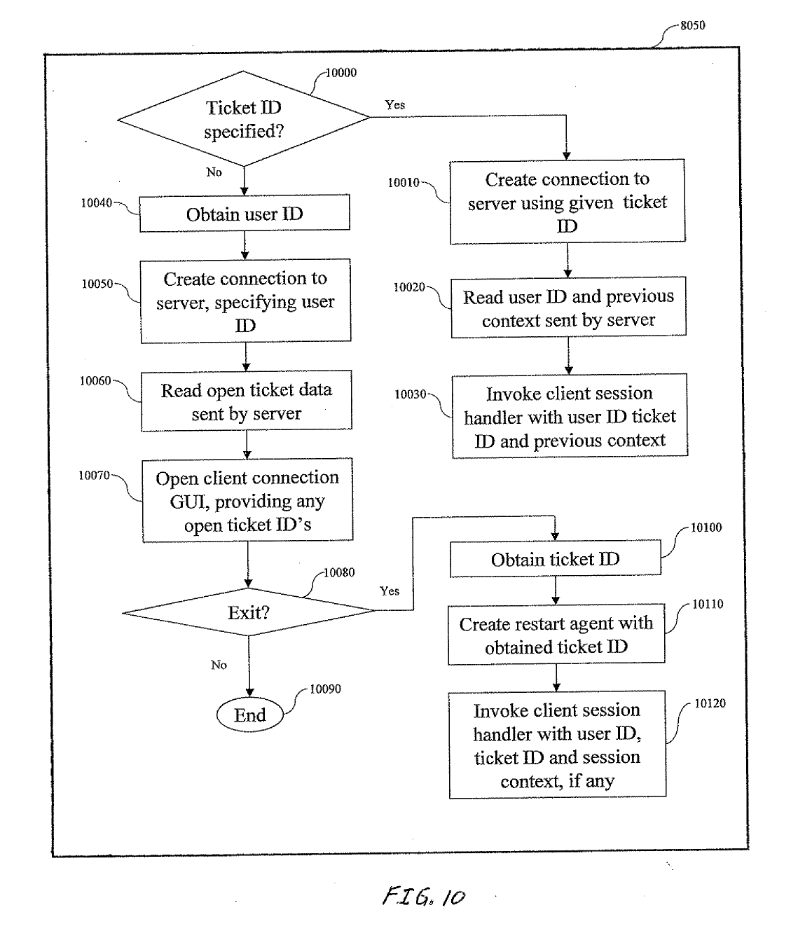

Referring to FIG. 4, a flow diagram illustrates the control flow of the connection handler 2050 shown in FIG. 2. The connection handler 2050 is called in response to a network request from a client (e.g., 1010) to start or restart a problem discussion or communication session between a client 1010 and an agent working from the server 1020. The connection handler 2050 provides the user or client with a list of all of their available problem tickets 4000. The connection handler 2050 first reads a user ID from the network connection to the client 1010. The connection handler 2050 then retrieves a list of all open tickets related to the user ID. For example, in a DB/2® relational database, this could be accomplished by requesting all open problem entries whose user ID cell matches the given user ID. Finally, in step 4020, the connection handler 2050 sends the list of the open problem ticket IDs to the client 1010, wherein each ticket ID may include a short summary of the related problem. The client's connection handler 8050 (as shown in FIG. 10) then takes this information and displays if to the customer at the client node 1010.

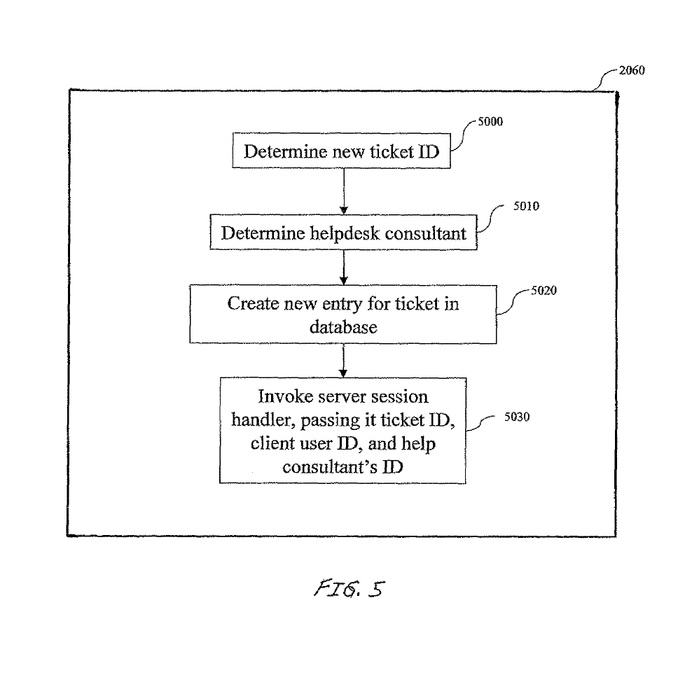

Referring to FIG. 5, a new ticket handler 2060 supports the creation of a new problem ticket, including creating a new ticket ID and assigning an agent, e.g., a consultant, at the server node 1020 to the new problem ticket. The new ticket handler 2060, first creates a new, unique ID for the problem 5000, and then determines which consultant to assign to the new problem 5010. The new ticket handler 2060 creates a new entry ticket in the database 5020. The handler 2060 passes the ticket ID and the consultant's ID to the server database handler 2100 for creating a new entry in the database for the new problem. Every entry has a unique ticket ID associated with and contained in the entry. Finally, the new ticket handler 2060 invokes the server session handler 2090, passing the server session handler 2090 the ID of the user, the ticket ID, and the assigned consultant 5030.

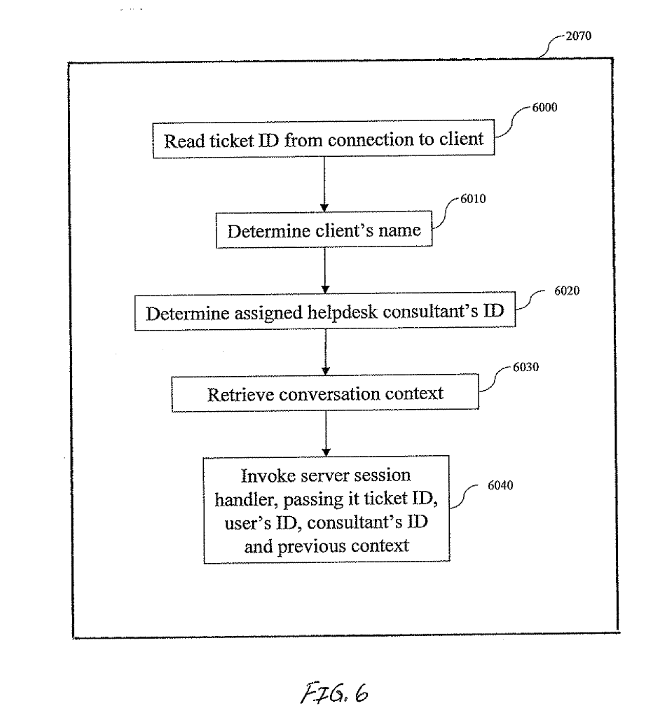

Referring to FIG. 6, the previous ticket handler 2070 connects a customer to the data and consultant from a still-open problem ticket. The previous ticket handler 2070 first reads the requested ticket ID from the network connection to the client 6000. Next, the handler 2070, retrieves the user's ID from the server database handler 2100 using the ticket ID, step 6010. The handler 2070 retrieves the help consultant's ID from the server database handler 2100 using the ticket ID, step 6020, and then, the handler 2070 retrieves any prior context (e.g., conversation text, messaging, voice) related to the ticket 6030. Finally, the server session handler 2090 is invoked, and passed the ID's of the ticket, including the user, and the consultant, as well as any prior discussion context related to the problem 6040.

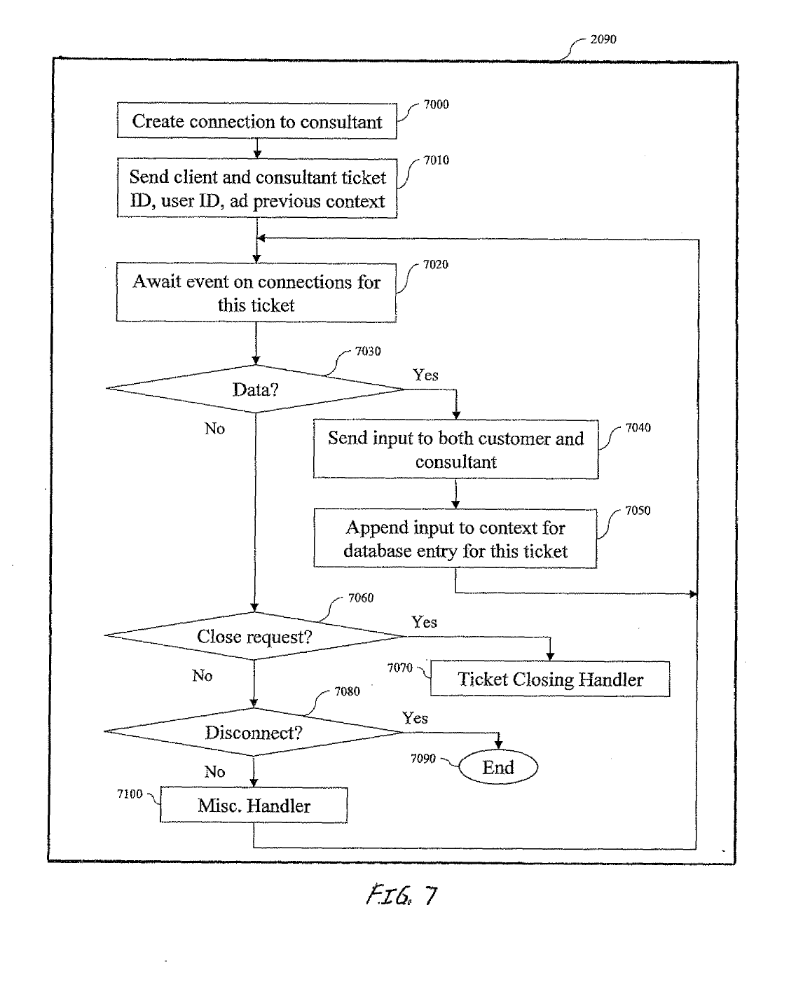

Referring to FIG. 7, the server session handler 2090 handles the flow and logging of data for a given problem conversation, as well as handling disconnections and close requests. When invoked, this handler 2090 is passed the ID's of the problem ticket, the relevant user, and the consultant assigned to the given problem ticket, as discussed above in relation to step 6040. The handler 2090 is also passed any previous discussion context related to the problem (e.g., conversation text). Referring to step 7000, the handler 2090 first creates a connection to the relevant consultant. The ticket ID, user ID and previous context, if any, are sent to both the client and the consultant 7010. Next, the handler 2090 awaits either input or event from either the connection to the user or the consultant 7020. Once input is received, the handler 2090 checks whether the input is problem resolution related data, e.g., discussion 7030. If the input is problem related, the data is sent to both the user and the consultant 7040, which data is added to the problem context for the ticket 7050 in the database 2100. If the input is not problem data, then the handler 2090 checks whether it is a close request from the user 7060. If the input is a close request, the ticket closing handler 2080 is invoked 7070, and the ticket closing handler 2080 is passed the ticket ID. If the input is not a close request, and the handler 2090 determines that the client has ended their session, then the handler 2090 terminates the session 7090. If the client did not end their session, then a miscellaneous handler 7100 is invoked, and the server session handler 2090 awaits inputs or events for a ticket 7020.

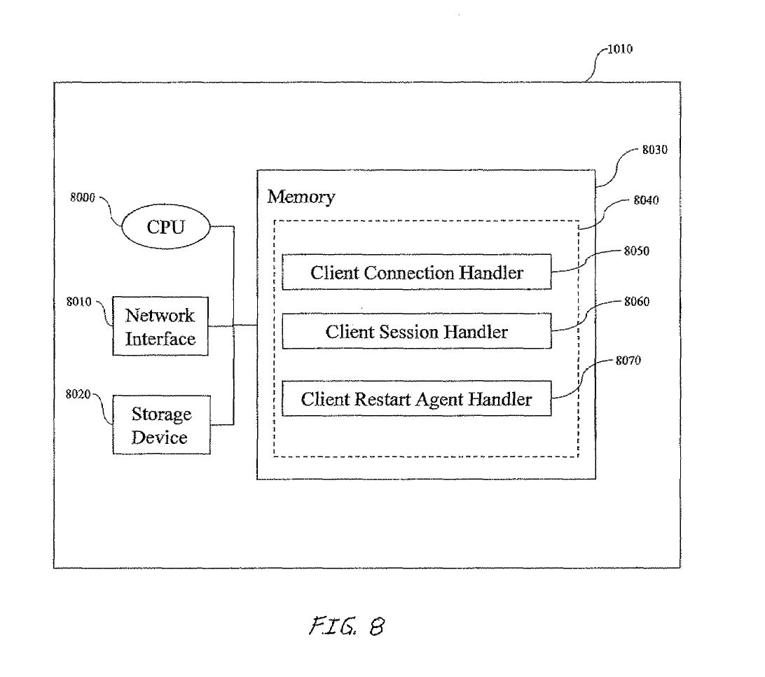

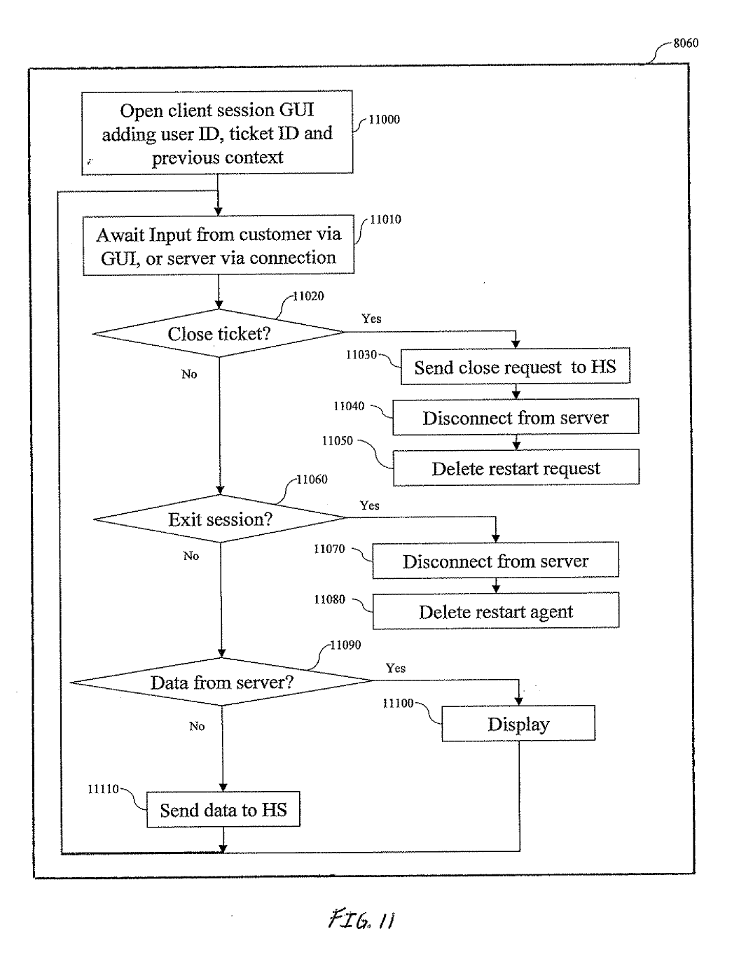

Referring to FIG. 8, the client 1010 is depicted in more detail. Client 1010 may comprise any computing node that is able to load and execute programmatic code and communicate via a network, including, for example, an IBM® ThinkPad® running Windows XP®. Additional platforms include network-connectable mobile (i.e., portable) devices, for example, Blackberry® by RIM®, as well as smart cellular telephones (i.e., devices which can act as a cellular telephone as well as run network applications), e.g., Nokia® 90008 by Nokia®. As shown in FIG. 8, client 1010 may include a processor device, CPU 8000, a network interface 8010, a storage device 8020 such as a magnetic or optical disk storage or a direct access storage device (DASD), and a memory 8030, such as random access memory (RAM). In one embodiment, the client node 1010 computer logic 8040 is computer executable code that is loaded from a remote source (e.g., over the network 1030 via the network interface 8010), local permanent optical (CD-ROM), magnetic storage (such as disk), or DASD 8020 into memory 8030 for execution by CPU 8000. In one embodiment the memory 8030 includes computer readable instructions, data structures, program modules and application interfaces forming multiple components: a client connection handler 8050 (shown in FIG. 10), a client session handler 8060 (shown in FIG. 11), and a client restart agent handler 8070 (shown in FIGS. 10 and 11).

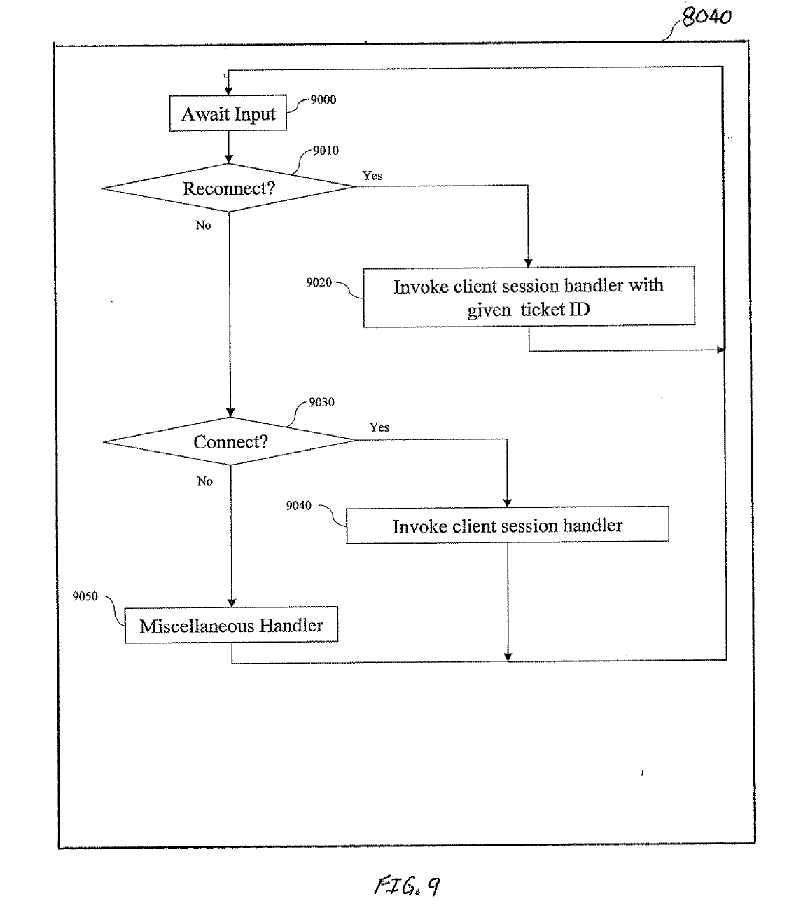

Referring to FIGS. 8 and 9, control flow of the client connection handler 8050 of the client's logic 8040 (shown in FIG. 8) begins with the client logic 8040 waiting for an input. When an input is received by the client logic 8040, the client connection handler 8050 determines whether the input is a reconnection request by ascertaining if the input includes a ticket ID. If the client connection handler 8050 determines that the input is a reconnection request, the handler 8050 invokes the client session handler 8060, after which, the handler 8050 returns to awaiting an input 9000 (shown in FIG. 9). If the input is not a reconnection request, then the handler 8050 checks whether the input is a connection request 9030. If the input is a connection request, the connection handler 8050 invokes the client session handler 8060, in step 9040, and returns to await an input 9000. If the input is not a connection or reconnection request, then the input is directed a miscellaneous handler 9050 and the handler 8050 return to await an input 9000.

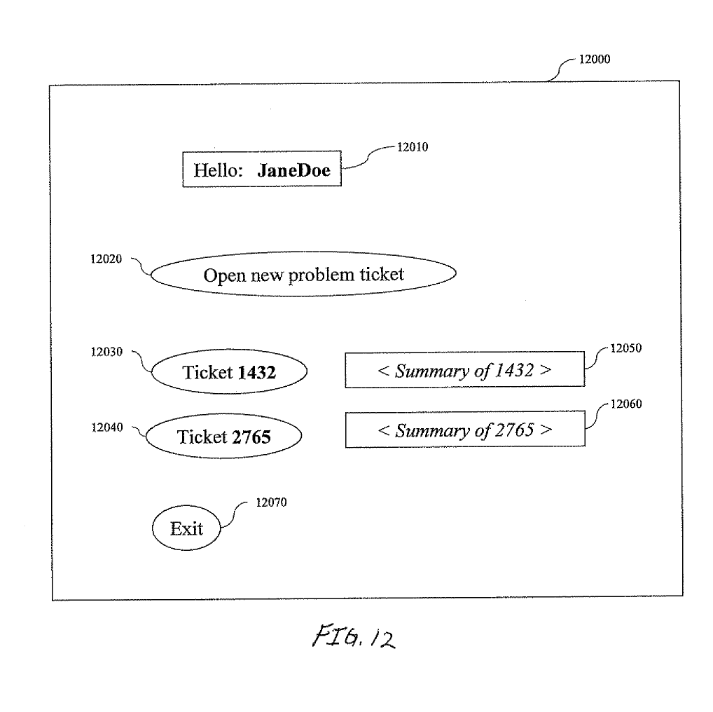

Referring to FIGS. 8 and 10, the client connection handler 8050 opens the communications links between a customer's client 1010 and the server 1020. Opening the communications link includes allowing users to start new problem discussions as well as continuing existing ones that have not yet been closed. The connection handler 8050 first checks whether a ticket ID was passed to it as a parameter 10000. If so, the handler 8050 creates a network connection to the server's previous ticket handler specifying the ticket ID 10010. Next, the user ID and previous context data (e.g., conversation text) sent from the server are read from the network connection 10020. Finally, the client session handler 8060 (shown in FIG. 8) is invoked and is passed the ticket ID, the user ID and the previous context data 10030. If no ticket ID is passed in step 10000, the client connection handler 8050 first obtains the customer's user ID. This can be achieved, for example, either by reading the customer's user ID from a file, or by reading the response to a dialog with the customer. The handler 8050 creates a connection to the server's connection handler 2050 and passing the connection handler 2050 the user's ID 10050. The handler 8050 then reads the list of previous, remaining open ticket ID's that are sent by the server 1020 via the network connection 10060, which list may include brief summaries of each open problem. Next, the client connection GUI 12000, described in detail with reference to FIG. 12, is opened and populated with the open ticket information along with the user ID 10070. According to the user's selection 10080, if the user selects exiting, then the handler 8050 terminates the session 10090. If the user does not select exiting the program 10080, then the user either specified a previous ticket, or requested a new one. Thus, in either case the server 1020, responds with the user's ID, the new or previous ticket ID 10100, and, if relevant, prior context data. In step 10100, the client connection handler 8050 reads all of this information from the network connection. Next, the client restart agent handler 8070 (shown in FIG. 8) is called and asked to create a restart agent for the given ticket ID 10110. The job of the client restart agent handler 8070 (shown in FIG. 8) is whenever the client 1010 (shown in FIG. 1) is restarted is to make a request to the client connection handler 8050 (shown in FIG. 8) to open a session for the given ticket ID (i.e., a reconnect request). For example, in a UNIX® or Linux® system this can be accomplished by adding an invocation line to a specified file (e.g., “/etc/services” file). In Windows®, for example, this could be accomplished by adding a file containing a restart batch command to the system's startup folder. Finally, the client session handler 8060 (shown in FIG. 8) is invoked and is passed the ticket ID, the user ID and any previous context 10120.

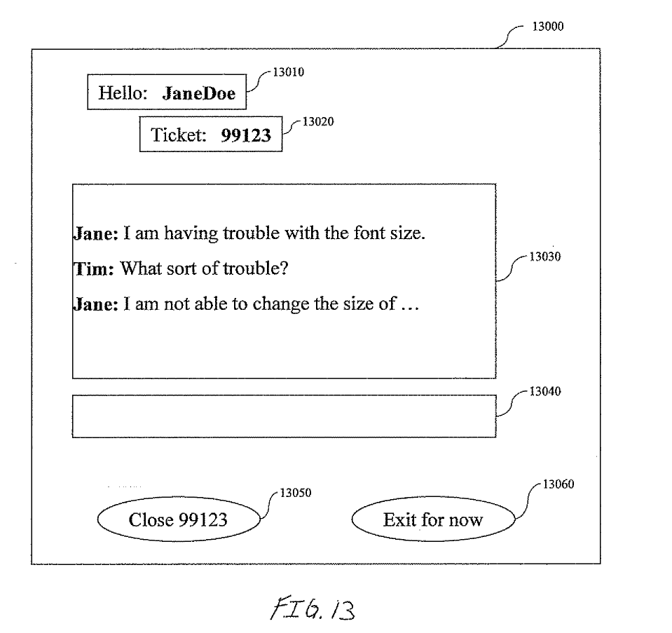

Referring to FIG. 11, the control flow of the client session handler 8060 (shown in FIG. 8) supports the communications between a customer and consultant or agent. As shown in step 11000, the client session handler 8060 begins by opening the client session graphical user interface (GUI) 13000 (shown in FIG. 13), filling the session with the ticket ID, user ID and previous context data passed to it by the client connection handler 8050 (shown in FIG. 8). Then, the handler 8060 awaits input from either the user or from the network connection 11010. When an input is received, the input is checked to determine if the input is a request to close the current ticket 11020. If the input is a request to close the current ticket, then a close request is sent to the server 1020 (FIG. 1), step 11030. Further, the network connection is dropped 11040, and a request is sent to the client restart agent handler 8070 to delete the existing restart agent for the current ticket ID 11050. This can be accomplished by either deleting the entry from the specified file (e.g., “/etc/services”) file in UNIX®/LINUX®, or deleting the relevant batch file in the startup folder for Windows®.

When an input is received 11020 and determined to not be a close request, step 11060 determines if the input is a request from the user to exit the session. If the input is a request to exit the session, then the connection is dropped 11070, and a request is sent to the client restart agent handler 8070 (shown in FIG. 8) to delete the existing restart agent for the current ticket ID 11080. If the input is not a request to exit the session 11060, and the input is determined to be context data from the server 11090, then the handler 8060 (shown in FIG. 8) displaying the data 11100 by appending it to the context area 13030 (shown in FIG. 13) in the client session GUI 13000 (shown in FIG. 13), and returns to await input 11010. If the input is not context data, the input data must have come from the client via the client session GUI's input box 13040, thus, the data is then sent 11110 to the server session handler 2090 (shown in FIG. 2), and the handler 8060 returns to await another input 11010.

Referring to FIG. 12, the client connection GUI interface 12000 according to an embodiment of the present disclosure enables a customer to start new problem discussions as well as to restart existing problem discussion. As shown, the GUI interface 12000 contains a one text box 12010 that indicates the user's ID. Below the text box 12010 is a button 12020 which selection signals a request to open a new problem. Additional buttons 12030 and 12040 can be used to request tickets 1432, reference number 12030, and 2765, reference number 12040, with summary information for each of these tickets in text boxes 12050 and 12060, respectively. It is understood that more than the two previous tasks shown in FIG. 12 can be available in other embodiments according to the invention. In an alternative embodiment where no open tasks are presented, then buttons 12030 and 12040 and respective text boxes 12050 and 12060 would not appear. Further, the presence of a great number of previous tasks could be accommodated, for example, with scroll bars. In addition, another button 12070 available on the GUI interface 12000 is selected when the user wishes to terminate the current session. The button 12070 links to an exit request sent to the client session handler 8060 (shown in FIG. 8).

Referring to FIG. 13, a client session GUI interface 13000 illustrates one embodiment of the present invention, wherein a customer can discuss a given problem with a consultant or agent assigned to a problem. The GUI interface 13000 includes a text box 13010 indicating the user's ID, and another text box that indicates the ID of the current ticket. A text display area 13030 includes data from a discussion during a session between a user and a consultant or agent where each entry is preceded with the name of the party writing the text. As described regarding FIG. 11, new data is appended to the text display area 13030 whenever it is received by the client session handler 8060. Below the text area 13030 is a text input area 13040 where users can input data such as text and/or graphics. Once the text or graphics is entered, a user may send the text to the client session handler by, for example, the user pressing enter or carriage return-line feed on a keyboard, then the data is sent to the client session handler 8060 (shown in FIG. 8). Another button 13050 includes the ticket ID and when chosen by the user causes a close request to be sent to the client session handler 8060 (shown in FIG. 8). Another button 13060, when chosen by the user, causes an exit request to be sent to the client session handler 8060. The exit request may also display the ticket ID (not shown).

Thus, according to the present invention, restarting a communication session between a customer and an agent when the communication is interrupted abnormally is accomplished without losing the correspondence therebetween. Advantageously, the client 1010 is automatically reconnected to the helpdesk service when their computer is restarted, with the reconnected communication having the entire context of the previous conversation, as well as the same helpdesk consultant. Further, the client 1010 is not able to reconnect to the assigned helpdesk consultant once the given problem been resolved, or in another scenario where the session has been terminated for a specified period of time. Another advantage of the present invention includes the client reconnecting to other open problem ticket(s), connected to the original consultant, and provided all the previous conversation from previous sessions related to the given problem.

While the present invention has been particularly shown and described with respect to preferred embodiments thereof it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A system for recovering from an interruption of communication on a network between computer users, comprising:
a computer network connecting a plurality of users using computers in a communication session; and
a computer readable medium encoded with a computer program embodied therein, and the computer readable medium connected to at least one of the users' computers for storing generated communications between the users during the communication session, and the computer program reconnecting the session between the users and restoring the generated communications between the users after detecting an interruption of the session between the users.

2. The system of claim 1, wherein the computers include a server including the computer readable medium and a client computer.

3. The system of claim 2, wherein the session is asynchronous.

4. The system of claim 1, further including an application server including the computer readable medium manages the session between the plurality of users.

5. The system of claim 4, wherein a customer service agent is communicating using the server with a customer using a client computer.

6. The system of claim 1, further including a servicing computer including the computer readable medium and communicating with the users computers.

7. The system of claim 1, wherein the program initiates deleting the generated communications of a completed communication session from the computer readable medium.

8. The system of claim 1, wherein the session is synchronous.

9. The system of claim 1, wherein the program provides a link to each of the users to reconnect the session.

10. The system of claim 1, wherein the generated communications include text and/or voice communications.

11. The system of claim 1, wherein the program does not allow reconnection to a previous user by another previous user after expiration of the communication session.

12. The system of claim 11, wherein the expiration of the communication session includes a specified time and/or the communication session has been completed.

13. A method for recovering from an interruption of communication on a network between computer users, comprising:
connecting via a computer network a plurality of users using computers in a communication session;
generating communications between the users during the communication session;
storing the generated communications between the users;
detecting an interruption of the session between the users;
reconnecting the session between the users; and
restoring the generated communications between the users.

14. The method of claim 13, further including blocking reconnection between the users after a specified period of time and/or after completing the session between the users.

15. The method of claim 13, further comprising deleting the generated communication after the communication session is completed.

16. The method of claim 13, wherein reconnecting the session includes sending each of the users a link to reconnect the session, and selecting the link by the users reconnects the session.

17. A computer readable media having computer readable program code embodied therein for executing a method for recovering from an interruption of communication on a network between computer users, the computer readable program code configured for executing method steps comprising:
connecting via a computer network a plurality of users using computers in a communication session;
generating communication between the users during the communication session;
detecting an interruption of the session between the users;
reconnecting the session between the users; and
restoring the generated communication between the users.

18. The method of claim 17, further comprising deleting the generated communication after the communication session is completed.

19. The method of claim 17, wherein reconnecting the sessions includes sending each of the users a link to reconnect the session, and selecting the link by the users reconnects the session.

20. A computer program product embodied in a computer-readable medium encoded with a computer program therein for executing a method for recovering from an interruption of communication on a network between computer users, the computer program product comprising:
displaying generated communications by the users during a communication session;
reconnecting the session between the users after detecting the communication session has been interrupted; and
restoring the generated communication between the users.
